(19) United States
(12) Patent Application Publication
(10) Pub. No.: US 2009/0254629 A1
(43) Pub. Date: Oct. 8, 2009

(54) METHOD OF DEFINING EMAIL IMPORTANCE BASED ON RECIPIENT

(75) Inventors: Afua A. N. Bruce, Austin, TX (US); Michael Reed, Pflugerville, TX (US); Robert V. Williamson, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, Armonk, NY (US)

(21) Appl. No.: 12/099,310

(22) Filed: Apr. 8, 2008

(51) Int. Cl. G06F 15/16

(52) U.S. Cl. 709/207

(57) ABSTRACT

A system and method for efficient electronic communication, which allows the user to address an electronic communication to a plurality of recipients each having a corresponding email address, wherein each of said recipients is assigned to one of a plurality of categories of recipients, and assign a delivery priority to each category of recipients without regard to the identity and number of recipients in each category of recipients, wherein a user is not required to assign a delivery priority to individual recipients.

### BACKGROUND OF THE INVENTION

1. Technical Field

The present invention relates in general to communicating via electronic mail messages, in particular to enhancing the reliability of communication, and more particularly to managing electronic mail messages.

2. Description of the Related Art

Electronically-communicated messages (“electronic mail messages”) such as email, paging messages, and voicemail have become increasingly popular and pervasive in recent years. For the creator of an electronic mail message, the ability to send the message to one or more recipients with a certain delivery priority provides for efficient communication. Such communication via electronic mail messages has become common in both business and personal settings. Sending emails with different levels of priority is a useful feature that allows the sender more control over how quickly the recipients open their correspondence.

Most email clients will allow the sender to specify a minimum of three levels of delivery priority within the range of low, normal, and high, with normal set as the default. The delivery priority setting applies to all recipients, no matter who they are or if they are on the “To:”, “cc:”, or “bcc:” list. However, there are times where only certain recipients need to read an email urgently, while others can read at their leisure. The only currently available method is to send multiple copies of the same email, with the recipient list manually separated based on the desired delivery priority. Therefore, the need exists for a sender to be able to send an email to multiple parties without having the same delivery priority set across all categories of recipients.

### SUMMARY OF THE INVENTION

It is therefore one object of the present invention to provide an improved method and system of communicating via electronic mail messages, in particular to enhancing the reliability of communication, and more particularly to managing electronic mail messages.

The foregoing objects are achieved as now described: a system and method are disclosed for transmitting an electronic mail message to one or more intended recipients, which allows a user to address an electronic communication to a plurality of recipients each having a corresponding email address, wherein each of said recipients is assigned to one of a plurality of categories of recipients, and the user can assign a delivery priority to each category of recipients without regard to the identity and number of recipients in each category of recipients, wherein the user is not required to assign a delivery priority to individual recipients.

At the time of sending an electronic mail message, a sender can set the delivery priority on a per-category basis or between the “To:”, “cc:”, and “bcc:” lists. One embodiment includes check-boxes next to each recipient/list, and another embodiment includes the option of right-clicking on each recipient category which enables a pop-menu for user selection of delivery priority for each recipient category. The system then sends an electronic message to designated recipients with the selected delivery priorities: low, medium, or high.

### BRIEF DESCRIPTION OF THE DRAWINGS

FIG. 1 is a diagram of a network of computers with the ability to send and receive electronic mail messages in which the method and system of the present invention may be practiced;

FIG. 2 is a logic flow chart of the process of transmitting an electronic mail message where the sender has the option of changing the delivery priority for each recipient category in accordance with the method and system of the present invention;

FIG. 3 is a logic flow chart of the process of adjusting delivery priority for each category of recipients based upon user input, in accordance with the method and system of the present invention; and

FIG. 4 is a pictorial representation of a graphical user interface of user-selectable icons that the sender can select in order to specify delivery priority for each category of recipients, according to one embodiment of the invention.

### DETAILED DESCRIPTION OF THE INVENTION

The illustrative embodiments contained herein provide a system, method, and program product for transmitting an electronic mail message to one or more intended recipients, which allows a user to address an electronic communication to a plurality of recipients each having a corresponding email address, wherein each of said recipients is assigned to one of a plurality of categories of recipients, and the user can assign a delivery priority to each category of recipients without regard to the identity and number of recipients in each category of recipients, wherein the user is not required to assign a delivery priority to individual recipients.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is therefore not to be taken in a limiting sense, and the scope of the present invention is defined only by the appended claims. Within the descriptions of the figures, the specific numerals assigned to the elements are provided solely to aid in the description and are not meant to imply any limitations (structural or functional) on the invention.

It is understood that the use of specific component, device and/or parameter names are for example only and are not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

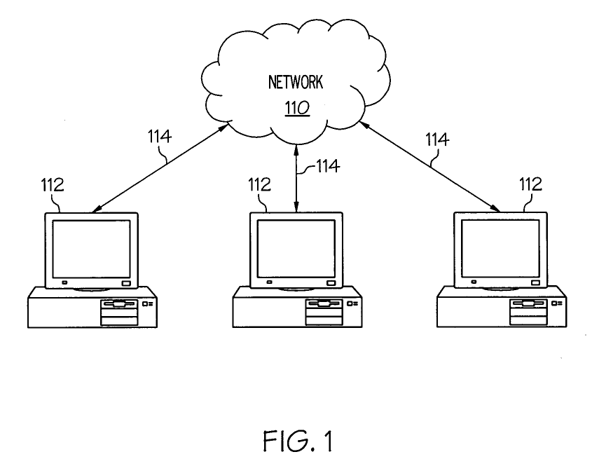

With reference now to the figures, and in particular to FIG. 1, there is illustrated a network 110 having a plurality of network-connected computers 112, each connected to network 110 and capable of sending and receiving electronic mail messages 114. Several distributed computer systems may exist in network 110, including computer 112. In one embodiment, computer 112 may be a laptop computer. In another embodiment, computer 112 may be a PDA or any other device used to transmit electronic mail messages. As depicted, network 110 may send and receive electronic mail messages to and from computer 112. Any conventional electronic mail program may be utilized to fulfill the sending and receiving of electronic mail messages on a computer, when modified to function as described herein.

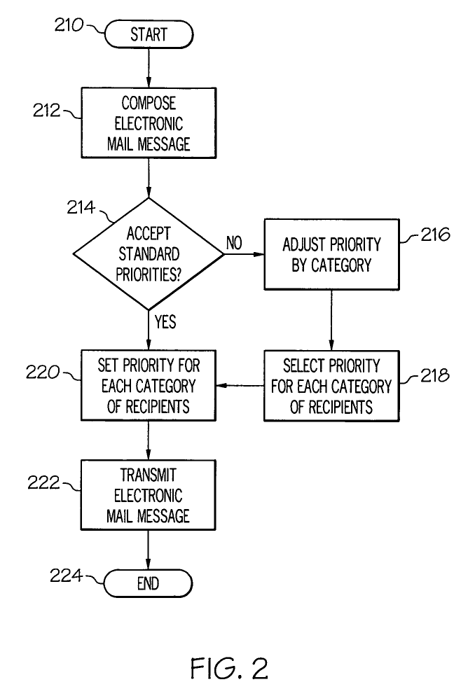

Referring now to FIG. 2, there is illustrated a logic flow chart of the process of transmitting an electronic mail message where the sender has the option of changing the delivery priority for each recipient category in accordance with the method and system of the present invention. The process comprises the steps of: composing an electronic mail message, accepting standard priorities with the option of adjusting priority by category and selecting priority for each category of recipients, setting priority for each category of recipients, and transmitting an electronic mail message with selected delivery priorities. In the illustrated embodiment, the electronic mail messages being sent are electronic mail messages which are to be prioritized based upon sender selection of priority based on recipient category.

The transmission process begins with step 210, which depicts the process moving forward to step 212, which illustrates the sender composing an electronic mail message to one or more recipients. The process continues at step 214, which depicts that the sender may accept standard priorities, which may be preset to the following priorities per recipient category. For example, “To:” recipients may be designated for urgent delivery, “cc:” recipients may be designated for normal delivery, and “bcc:” recipients may be designated for low delivery priority. If the sender does not accept standard priorities, then the process continues to step 216, which illustrates that the sender may adjust delivery priority by category, wherein the sender may change the delivery priority for any recipient category among “To:”, “cc:”, and “bcc:” to delivery priorities of urgent, normal, or low. The process proceeds to step 218, where it is depicted that the sender may select a delivery priority for each category of recipients. The sender may input the delivery priority by selecting user-selectable checkboxes in an email, which may be presented near each category of recipient. Whether the sender has opted to accept standard priorities as illustrated in step 214 or whether the sender selected priorities for each category of recipients as depicted in step 218, the process then continues to step 220, where it is illustrated that the priority is set for each category of recipients. The process proceeds to step 222, which depicts that the electronic message is transmitted, followed by the process ending as illustrated in step 224.

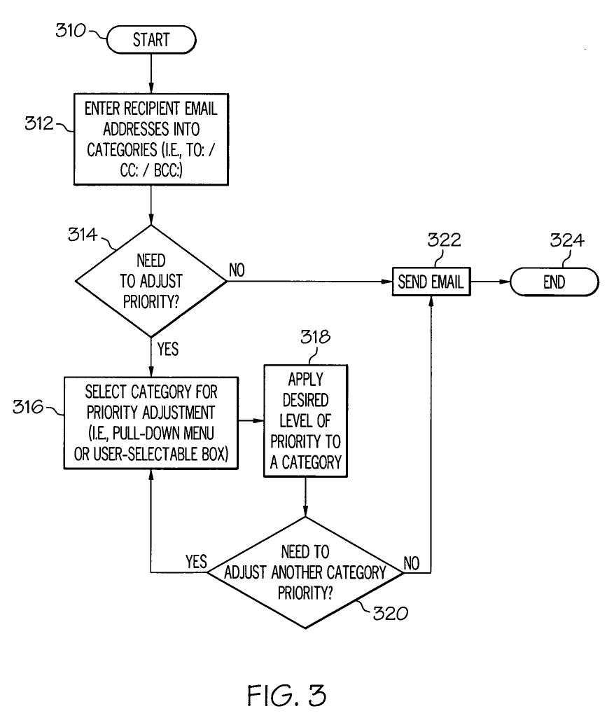

With reference now to FIG. 3, there is depicted a logic flow chart of the process of adjusting delivery priority for each category of recipients based upon user input, in accordance with the method and system of the present invention. The process comprises the steps of: entering recipient email addresses into categories (for example, “To:”, “cc:”, and “bcc:”), adjusting priority by selecting a category for priority adjustment with either a pull-down menu or user-selectable boxes, applying desired levels of priority to each category, and sending an email. In the illustrated embodiment, the electronic mail messages being sent are to be prioritized based upon sender selection of priority for each recipient category.

The process begins with step 310, which depicts the process moving forward to step 312, which illustrates the sender entering recipient email addresses into recipient categories (for example, “To:”, “cc:”, and “bcc:”). The process continues to step 314, which depicts that the sender may adjust priorities. If the sender chooses to adjust priorities, then the process continues to step 316, which illustrates that the sender may select a delivery priority for each category of recipients. The sender may input the delivery priority by selecting user-selectable checkboxes in an email, which may be presented near each category of recipient in one embodiment of the present invention, or the sender may be presented with a pull-down menu in another embodiment of the current invention. Once the sender selects a category for priority to adjust, the sender may apply the desired level of priority to a category by selecting a different priority than is presented as default, as is depicted in step 318. The sender is presented with the option of adjusting another recipient category delivery priority, as depicted in step 320. If the sender chooses to adjust another recipient category delivery priority, the process becomes iterative as it continues back to step 316. If the sender does not choose to adjust another recipient category delivery priority as depicted in step 320, or if the sender did not choose to adjust priorities initially, as depicted in step 314, then the process continues to step 322, which illustrates that the email is sent. The process then ends, as depicted in step 324.

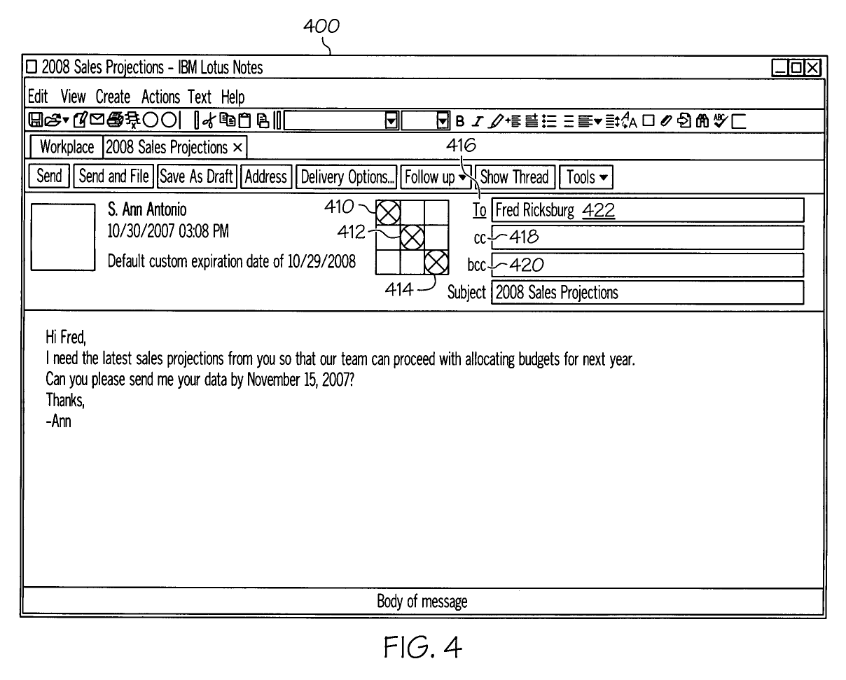

Referring now to FIG. 4, there is depicted a pictorial representation of a graphical user interface of user-selectable icons that the sender can select in order to specify delivery priority for each category of recipients, according to one embodiment of the invention. In this graphical user interface 400, there is illustrated a recipient field 422 which can be filled in with one or more recipients of an electronic mail message, and to whom the electronic mail message is transmitted upon the sending of an electronic mail message. The sender of the electronic mail message can add recipients to any of three categories of recipients: “To:” 416, “cc:” 418, and “bcc:” 420. In one embodiment, the sender can identify a delivery priority for each category by selecting a user-selectable icon that designates a delivery priority of urgent 410, normal 412, or low 414, each of which tags the electronic mail message with the respective delivery priority for the recipient category for which each delivery priority is selected. The delivery priority which the sender inputs can be different for each recipient category.

In the flow charts above, one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non-exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed:

1. A method for efficient electronic communication, said method comprising the steps of:
addressing an electronic communication to a plurality of recipients each having a corresponding email address, wherein each of said recipients is assigned to one of a plurality of categories of recipients; and
assigning a delivery priority to each category of recipients without regard to the identity and number of recipients in each category of recipients, wherein a user is not required to assign a delivery priority to individual recipients.

2. The method of claim 1, wherein a delivery priority is assigned to each of said categories of recipients and said delivery priority may be assigned to multiple categories of recipients.

3. The method of claim 1, wherein said delivery priority includes an indication of a level of importance attributable to said electronic communication as related to said plurality of recipients and a level of importance is distributed within said electronic communication as received by said plurality of recipients.

4. The method of claim 3, wherein said electronic communication is an email message being transmitted to a first and a second category of recipients, and said method further comprising displaying a first level of importance within said communication transmitted to said first category of recipients and displaying a second level of importance within said communication transmitted to said second category of recipients.

5. The method of claim 1, further comprising:
associating particular priorities with particular categories of recipients; and
storing said particular categories of recipients along with other categories of recipients within a distribution list prior to preparation of said communication for transmission.

6. The method of claim 1, further comprising the step of:
automatically associating a selected specific delivery priority to a category of recipients, such that each category of recipients entered into a first category field exhibits said selected characteristic independent of categories of recipients entered into a second category field.

7. The method of claim 1, further comprising the step of:
transmitting said electronic communication to said category of recipients along with said delivery priority to effect a displaying of said delivery priority in a received communication at a recipient's end of the transmission.

8. The method of claim 1, further comprising the step of:
indicating on a display device of a data processing system the delivery priority of each of said categories of recipients.

9. A system for efficient electronic communication, said system comprising:
means for addressing an electronic communication to a plurality of recipients each having a corresponding email address, wherein each of said recipients is assigned to one of a plurality of categories of recipients; and
means for assigning a delivery priority to each category of recipients without regard to the identity and number of recipients in each category of recipients, wherein a user is not required to assign a delivery priority to individual recipients.

10. The system of claim 9, wherein said assigning means enables assigning a delivery priority to each of said categories of recipients and said delivery priority may be assigned to multiple categories of recipients.

11. The system of claim 9, wherein said indicating means comprises a template form wherein a primary category of recipients receives a highest delivery priority, a secondary category of recipients receives a medium delivery priority, and a tertiary category of recipients receives a lowest delivery priority.

12. The system of claim 11, wherein the primary category of recipients is “To:”; the secondary category of recipients is “cc:”; and the tertiary category of recipients is “bcc:”.

13. The system of claim 11, further comprising:
means for indicating on a display device of a data processing system the delivery priority of each of said categories of recipients.

14. A computer program product for efficient electronic communication, said computer program product comprising:
a computer readable storage medium;
program instructions on said medium for:
addressing an electronic communication to a plurality of recipients each having a corresponding email address, wherein each of said recipients is assigned to one of a plurality of categories of recipients;
providing a pop-up menu of selectable priorities responsive to user manipulation; and
assigning a delivery priority to each category of recipients without regard to the identity and number of recipients in each category of recipients, wherein a user is not required to assign a delivery priority to individual recipients.

15. The computer program product of claim 14, wherein said program instructions for said assigning step enables assigning a delivery priority to each of said categories of recipients and said delivery priority may be assigned to multiple categories of recipients.

16. The computer program product of claim 14, wherein said program instructions for providing a pop-up menu includes:
program instructions for detecting a right click operation on said category of recipients; and
program instructions for automatically activating a list of available selectable options that may be associated with said electronic communication when transmitted to said category of recipients.

17. The computer program product of claim 14, wherein said program instructions further includes:
program instructions for transmitting the electronic communication to each recipient with the delivery priority assigned to the category of recipients for each recipient.

18. The computer program product of claim 14, further comprising the step of:
indicating on a display device of a data processing system the delivery priority of each of said categories of recipients.
